(19) United States
(12) Patent Application Publication
(10) Pub. No.: US 2012/0129114 A1
(43) Pub. Date: May 24, 2012

(54) Candle Wick System

(76) Inventor: Thomas J. Barresi, Stony Brook, NY (US)

(21) Appl. No.: 13/229,603

(22) Filed: Sep. 9, 2011

Related U.S. Application Data
(60) Provisional application No. 61/381,197, filed on Sep. 9, 2010.

(51) Int. Cl. F23D 3/18; F23Q 2/44; F21V 37/00

(52) U.S. Cl. 431/291; 431/325

(57) ABSTRACT

This invention relates to a candle wick system for use with a container, in particular, a system including a candle wick, a wick dip, utilized alone and in combination thereof; wherein the candle wick system is for use with a container populated by a fuel having a wick with a height, a variable cross-sectional area, and a thickness.

### CROSS REFERENCE TO RELATED APPLICATIONS

This application claims priority from U.S. Patent Application No. having Ser. No. 61/381,197 having a filing date of 9 Sep. 2010

### BACKGROUND OF THE INVENTION

This invention relates to a wick system, in particular, a wick system designed to increase the efficiency of the combustion, while simultaneously minimizing the probability of a safety hazard set forth herein below.

Historically, candles are generally comprised of a fuel, such as, inter alia, a wax (soy), paraffin, palm, coconut, rice, and/or blends thereof, and a mechanism for lighting, holding, and sustaining combustion, a wick, and a wick-clip assembly. Wherein wicks have been made from an array of cottons, whether braided, knitted, twisted, cotton wrapped about a core, paper, zinc, cotton, tin, etc., and wood. However, although a diversity of material has been incorporated therewith, there has been a common implementation in the industry, wherein the width of the wick is uniform over the entire length of the wick, with insignificant variance in diameter from top to bottom.

However, this feature, the uniform width, generally produces problems in container candles, or any pillar candle; wherein the combustion event descends into the body of the candle. The dynamics of the thermal generation and heat energy transfer change with the ever changing physical parameters of the combustive event. For example, the dissipation or emission of heat changes as the height of the combustion event drops from the apex to the base, as does the fuel environment, as does the fuel's viscosity and flow rate thereby yielding, in most candles, smoke, soot, overheating, tunnel, and inconsistent flames. Moreover, because of the high expectation of the production of inconsistent flames and safety hazards recognized in the industry, it is standard practice to provide safety labels on candles advising wick trimming, candle monitoring, and truncating the candle burn after four (4) hours.

Contemporarily in the candle industry, there are literally thousands of differing candle wicks in different materials and construction, yet they all have uniform dimensions from top to bottom of a wick. Hence there is a need for an improved candle assembly that minimizes, if not, eliminates the need for the above safety hazards/constraints.

### SUMMARY OF THE INVENTION

The present invention is directed to wick system having the primary advantage of providing a plurality of cross-sectional areas over the length of the wick, and a wick clip that snuffs out the flame while simultaneously acting as a radiator to dissipate heat.

One advantage of the present invention is to reduce the likelihood of explosion from concentrated heat so close to the candle base during the end of life of the candle.

A second advantage of the present invention is the increased efficiency of the candle fuel.

A third advantage of the present invention is increased stability of the combustion event, from the alpha to the omega.

A fourth advantage of the present invention, is the extension of the life expectancy of the candle via controlling the temperature of the combustive event.

A fifth advantage of the present invention, is by controlling the combustion event by optimizing the temperature and size thereof, yields increased efficiency of the evaporation of the fragrance, which maximizes the candles hot throw, or volume of evaporated fragrance.

Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 illustrates the present invention, namely, in use with a short container;

FIG. 2 illustrates the present invention, namely, in use with a tall container;

FIG. 3 illustrates the present invention, namely, in use with a shoulder container;

FIG. 4 illustrates he present invention, namely, in use with an artistic container;

FIG. 5 illustrates the present invention, namely, in use with a multilayer container;

FIG. 6 illustrates front view of the wick clip of the present invention;

FIG. 6A illustrates top view of the wick clip of the present invention;

FIG. 7 illustrates a front view of the present invention in use, namely, the wick and wick clip;

FIG. 7A illustrates a side view of the present invention in use, namely, the wick and wick clip;

FIG. 8 illustrates an alternative embodiment of the present invention, namely, the use of voids, reliefs, cutouts;

FIG. 9 illustrates the present invention, namely the plurality of shapes that may be used in FIG. 8; and

FIG. 10 illustrates the present invention, namely, a hollow cored wick.

FIG. 10A illustrates a top view of FIG. 10.

FIG. 10B illustrates a front view of FIG. 10 in use.

### DETAILED DESCRIPTION OF THE INVENTION

The following descriptions of the preferred embodiments are presented to Illustrate the present invention and are not to be construed to t the claims in any manner whatsoever.

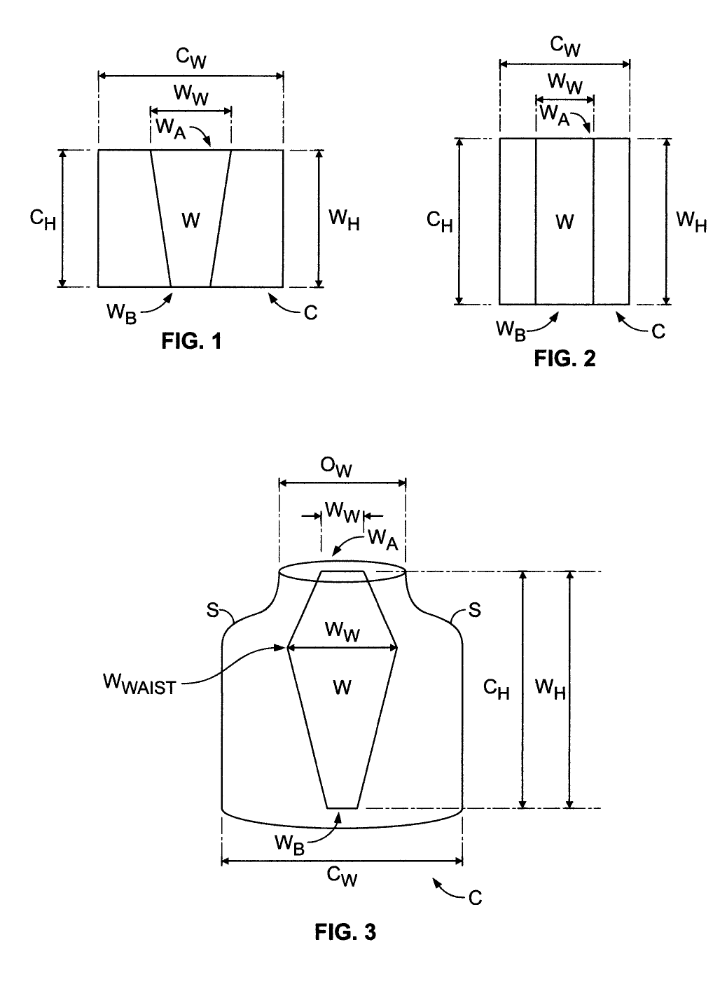

In reference to the drawings, namely FIGS. 1 to 10B illustrate the candle wick system 1.

This invention relates to a wick system 1, in particular, a wick system 1 designed to increase the efficiency of the combustion, while simultaneously minimizing the probability of a safety hazard set forth herein below.

A candle wick system 1 that is engineered to have a plethora of dimensions within a wick to control the parameters of the candles combustion, whether it is thicker (cotton) or wider (wood) to present and create a larger scale combustive event (more wick material to burn, larger surface area for more fuel flow (capillary action) and thus a larger flame radiating more heat energy, or conversely thinner (cotton) or narrower (wood) to physically scale back the size of the combustive event to reduce the flame size and overall radiant energy of the flame. More succinctly, a larger flame is hotter and has a quicker fuel burn, while a smaller flame is less hot and has a more gradual fuel burn. The shape of the wick of the wick system 1 is engineered to match the ability of any given container C so as to affect the candles combustion.

FIGS. 1 and 2 illustrate two examples of parallel walled containers, namely a short container in FIG. 1, and a tall container in FIG. 2. In FIG. 1, the short container C has a width C_{W} that is greater than the container's height C_{H}, (i.e., C_{W}>C_{H}) and exhibited here is a wick W having a height W_{H}, a thickness W_{T}, an apex and a base W_{A}, W_{B} each having a cross-sectional area influenced by their respective widths W_{WA}, W_{WB}, and a variable width W_{w}, wherein W_{WA}>W_{WB} particularly, the wick W having a large taper wherein heat from the combustion event is emitted easily through the top of the container C.

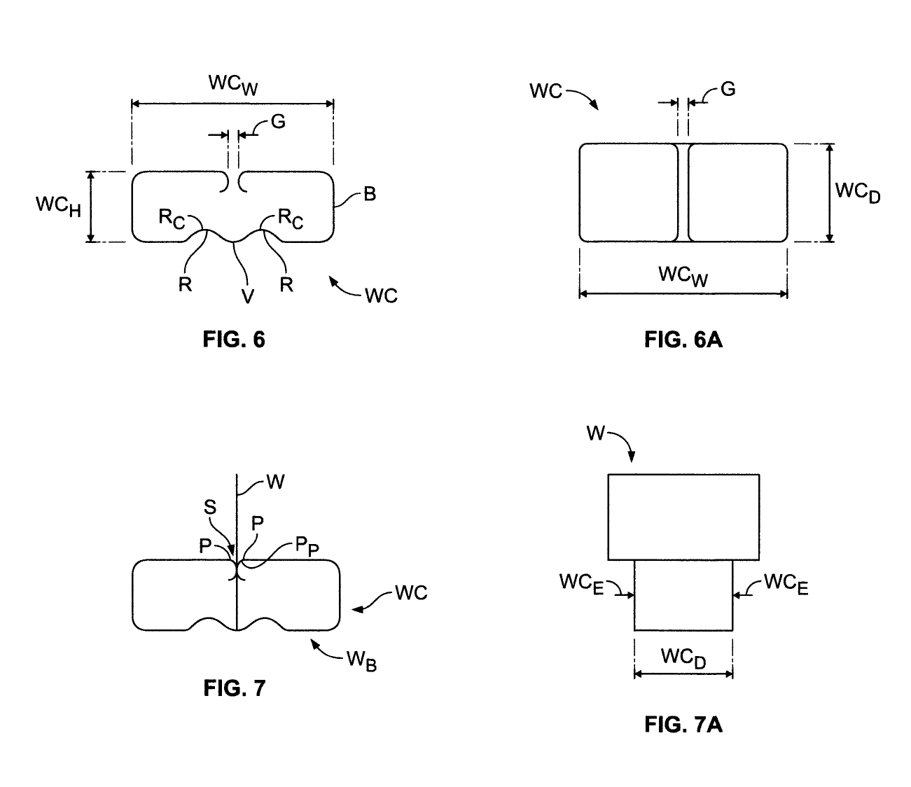

FIG. 2 illustrates a taller version of FIG. 1, however, here the container's height C_{H} is greater than the container's width C_{W}, (i.e., C_{H}>C_{W}), thus the wick W needs less of a taper or more simply phrased, a more gradual taper because the change in cross-sectional area, here attributable to solely to the width W_{w} because there are no reliefs, orifices, or the like, such taper is spread out over a greater height W_{H}, wherein heat is emitted readily at or near the top of the container C, however, the emission of the heat generated from the combustion event is increasingly more difficult as the height of the combustion event descends towards the base of the container C. In both illustrations, the height W_{H} is about the container's height C_{H}. Moreover, it should be noted, although FIGS. 1 and 2 illustrate the wick as a stand alone device, the wick may also be used in conjunction with the wick clip set forth herein below, and illustrated in FIGS. 6 to 7A.

FIG. 3 illustrates a shoulder container C which has an opening with smaller width O_{W} than the body of the container C_{W} (Le., O_{W}<C_{W}). In this embodiment, the applicable wick cross-sectional area, here attributable solely to the wick's width W_{w} due to the absence of any reliefs, orifices, or the like, wherein the wick's width W_{w} would better track the width of the container C_{w}, than a uniform width wick would. The present invention in FIG. 3, the top of the cross-sectional area of wick W is smaller at the top, then widens a bit as the container C flairs out to its maximum width, and then the cross-sectional area due to the width of the wick C_{w} tapers slowly as the height of the wick W_{H} descends towards the base. Moreover, the candle wick system 1 is for use with a shoulder container C populated by a uniform wax comprising a wick W having a height W_{H}, a variable cross-sectional area, and a thickness W_{T}, wherein said wick W has an apex W_{A} , a waist W_{WAIST} and a base W_{B}, wherein cross-sectional area of the waist W_{WAIST} is greater than the cross-sectional area of the apex WW_{A} and the cross-sectional area of the base WW_{B}; wherein the height of said wick W_{H} is about the height of the container C_{H}, wherein the waist W_{WAIST} is located at a height that is about the Tie plane as the lowest point of the shoulder S of the container.

An alternative shape for this figure would have the change in width of the wick W_{w} mimic the contour change of the container C_{W} for example, the silhouette of the wick would be a smaller version of the container in width.

Moreover, it should be noted, although FIG. 3 illustrates the wick W as a stand alone device, the wick W may also be used in conjunction with the wick clip WC set forth herein below, and illustrated in FIGS. 6 to 7A.

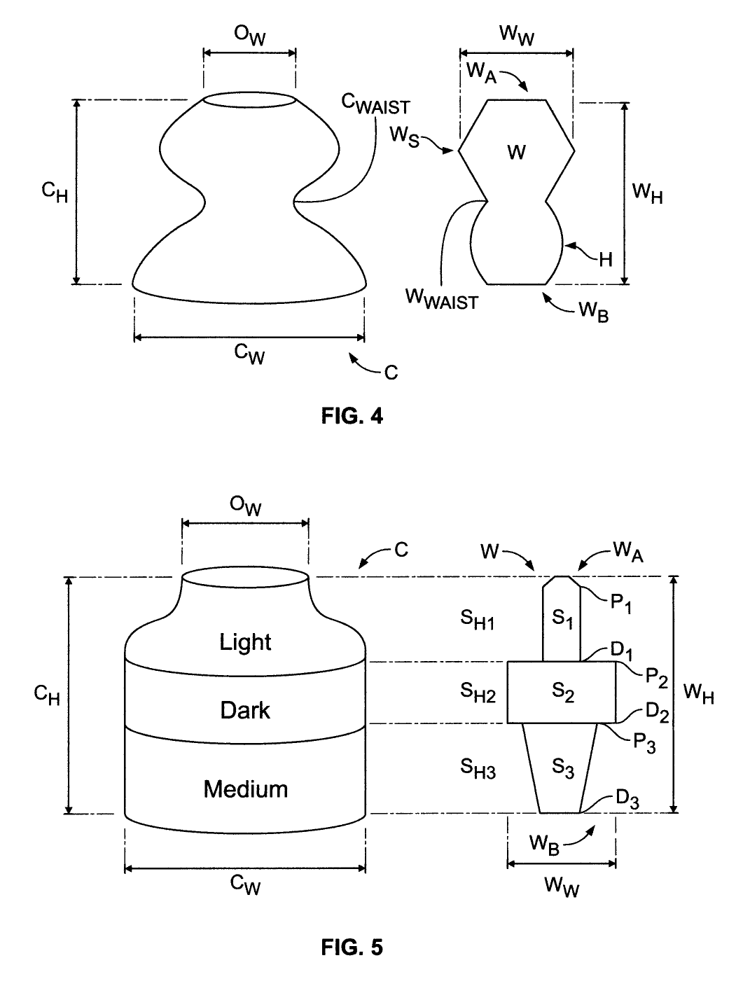

FIG. 4 illustrates an artistic container C, wherein the top of wick W is smaller to track the narrow opening width O_{W} of the top of the container C, the wick W tapers out tracking the shape of the container C, and then as the wick W approaches the base, the wick W narrows unlike container C, but consistent with FIGS. 1 to 3. Moreover, the candle wick system 1 is for use with an artistic container C populated by a uniform wax comprising a wick W having a height W_{H}, a variable cross-sectional area, and a thickness W_{T}, wherein said wick W has an apex W_{A}, a waist W_{WAIST} and a base W_{B}, wherein a shoulder W_{S} is located between the apex W_{A} and waist W_{WAIST} having a cross-sectional area greater than both the apex W_{A} and waist W_{WAIST}; the wick W further having a hip H located between the waist W_{WAIST} and base W_{B}, and having a cross-sectional area greater than both the waist W_{WAIST} and base W_{B}; wherein the height of said wick W_{H} is about the height of the container C_{H}; the height of the waist of the wick W_{WAIST} is located at a height that is about the same plane as the waist of the container C_{WAIST}.

Moreover, it should be noted, although FIG. 4 illustrates the wick W as a stand alone device, the wick W may also be used in conjunction with the wick clip WC set forth herein below, and illustrated in FIGS. 6 to 7A.

FIG. 5 illustrates a multilayer container C, which contains a plurality of different waxes, with a plurality of different colors, and/or plurality of different fragrances which will burn at a plurality of different rates. In this type of candle, the wick W is engineered to burn the wax differently based on the formula burn properties, design diameter of the container, and the changing thermal dynamics of the candle from apex to base. A taper is not required in the top layer of wax because it is a short layer, it is easy to burn due to the wax but is preferred due to the container shape, whereas the middle layer of wax is dark in color, so it is difficult to burn and requires a wider wick portion, and the base wax layer requires tapering of the wick VV because it is near the end of life of the candle, so the wick W safely burns down. Moreover, the candle wick system 1 is for use with a shoulder container C populated by a multilayer wax having a plurality of burn rates comprising:

a wick W having a height W_{H}, a variable cross-sectional area, and a thickness W_{T}, wherein said wick W has an apex W_{A} and a base W_{B}, having a plurality of sections S each having a height S_{H}, proximal and distal ends, wherein the height of each section is about the height of each layer of wax;

wherein the proximal end P1 of the first section S1 has a cross-sectional area less than the distal end D1 of the first section S1 wherein the height of the change in area is positioned about the height of the change of the shoulder of the container at the interface;

wherein the second section S2 has a cross-sectional area that is greater than the first S1;

wherein the proximal end P3 of the third section S3 has a cross-sectional area that is smaller than the distal end D2 of the second S2, and with a cross-sectional area that is greater than the distal end D3 of the third section S3 at the interface;

wherein the height of said wick W_{H} is about the height of the container C_{H}.

Moreover, it should be noted, although FIG. 4 illustrates the wick W as a stand alone device, the wick W may also be used in conjunction with the wick clip WC set forth herein below, and illustrated in FIGS. 6 to 7A.

Combining the combustion control of the wick W, in combination with the wick clip WC (aka clip) fabricated from metal so as to optimize the heat transfer of the wick W via the air. FIGS. 6 and 6A illustrate the front and top views of the wick clip WC. The wick clip WC is made from a metal, preferably tin plated, having a coating of about 50# coating wt with a 0.012 inch thick. It has a body B having a wall with a width of 0.500 inches +/−0.020 inches, wherein the body B is symmetrically shaped left to right, where in the center of the base there is a valley V having a radius of about 0.020 inches formed between two ribs R wherein each rib R has a radius of about 0.060 inches, and a center R_{c}, wherein the respective centers R_{c} are about 0.160 inches away from each other; wherein the wall extends outwardly from the ribs R respectively, make a 90 degree turn vertically upwardly via a curl having a radius of about 0.080 inches forming an overall width of the clip WC_{W} of about 0.625 inches +/−0.020 inches, wherein the walls continue extending vertically and making a 90 degree turn towards itself having a radius of about 0.080 inches and forming an overall clip height WC_{H} of about 0.250 inches +/−0.020 inches, wherein the respective walls then making a curl inwardly having a radius about 0.03125 inches (rad= 1/32 inches) forming a gap G between the pincers P of about 0.010 for a single wood wick, and about 0.030 for a double wood wick, with a maximum gap G of about 0.017 for the single wood wick. Wherein it is envisioned the thickness of a single wood wick is about 0.020 inches +/−0.003 inches

FIG. 7 illustrates an additional safety aspect, namely, the end of life flame extinguishment or snuff out feature located at point the pinch point PP. For flat wicks, more specifically flat wicks made from wood, the bottom of the wick W_{B} is fabricated with the same diameter W_{D} of the wick clips WC_{D} (i.e., W_{D}=WC_{D}), so when the wick W is inserted into the slot S, the wick W is pinched between the two (2) sides of the slot S formed by the pincers P of the wick clip WC, and extend laterally no further than the edges of the wick clip WC_{E}, see illustration in FIG. 7A. The interface between the wick W and the pincers P physically reduces and/or stops capillary action from occurring within the wick W itself, thereby causing the combustion event to die out as the combustion event approaches this intersection PP, The wick clip WC forms a barrier which cuts off liquid fuel flow, thus starving out the combustion event at a safe and controlled height away from the base of the container C_{B} (typically glass).

A large majority of unwanted/undesired fires start by, inter alia, candles exploding, which occur at the end of life of the candle, due largely impart to the continuing buildup of trapped heat and the diminishing volume of liquid/fuel in the burn pool to dissipate the heat, while convection currents transfer that heat energy throughout the total area/volume of the candle, The shape of the wick W and the wick clip WC continues the present invention's effectiveness in controlling the candle's combustion from cradle to grave.

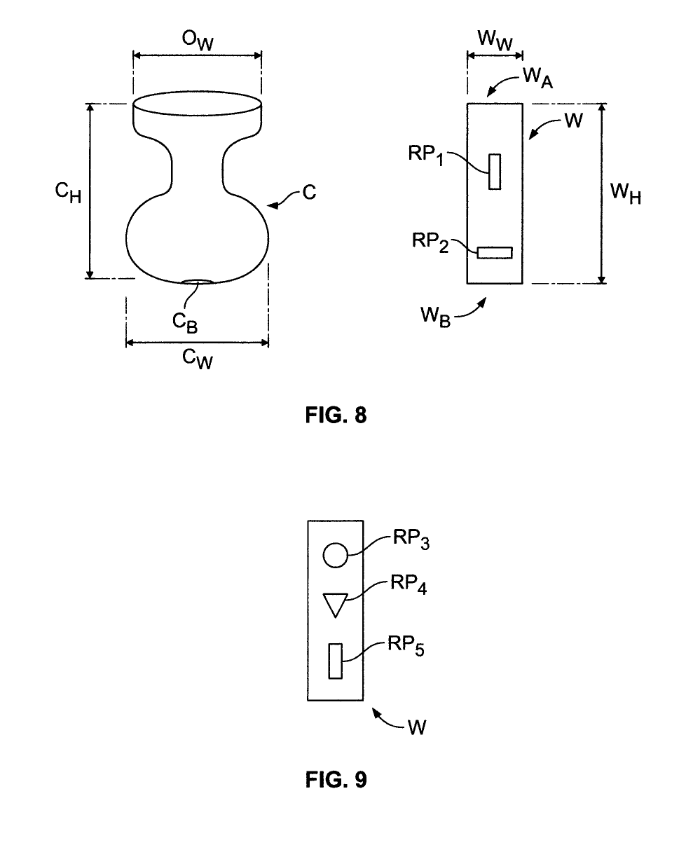

FIG. 8 illustrates a further method of controlling the combustion event is through altering the cross-sectional area by altering the shape of the wick W internally by implementing voids, cutouts, or reliefs, which may be implemented alone to alter the combustion event, or may be incorporated with the variation of width technique set forth herein above. Cutout RP1 is designed for the trimmer waistline of the container C, whilst cutout RP2 illustrates the end of life safety feature to reduce combustion event as it approaches the wick clip WC and due to the reduced width of the container C_{W} as the container C approaches the base C_{B}.

Again, the size and shape of the cutout depends on the varying cross-sectional area, width C_{W}, and height C_{H} of the change of the container C. It is envisioned that a plethora of geometrical shapes of cutouts may be employed depending on the need of the geometrical shape of the container C, wherein a subset of envisioned shapes are illustrated in FIG. 9. For example, inter alia, RP3, a circular cutout would be used for a rounded portion of the container, whereas cutout RP4, an inverted equilateral triangle would be used for an inverted angular portion of the container, and finally, cutout RP5, a rectangular would be used for a thinning waistline of a container.

Moreover, the candle wick system 1 is for use with a spittoon like shaped container C comprising:

a wick W having a height W_{H}, a variable cross-sectional area, and a thickness W_{T}, wherein said wick W has an apex W_{A} and a base W_{B},

wherein the cross-sectional area of the wick W Is reduced between the apex W_{A} and base W_{B} via a first relief portion RP1 located about the height of the waist of the container;

wherein the cross-sectional area of the wick W is reduced between the apex W_{A} and base W_{B} via a second relief portion RP2 located near the base W_{B};

wherein the height of said wick W_{H} is about the height of the container C_{H}.

It should be noted, although FIG. 8 illustrates the wick W as a stand alone device, the wick W may also be used in conjunction with the wick clip WC set forth hereinabove, and illustrated in FIGS. 6 to 7A.

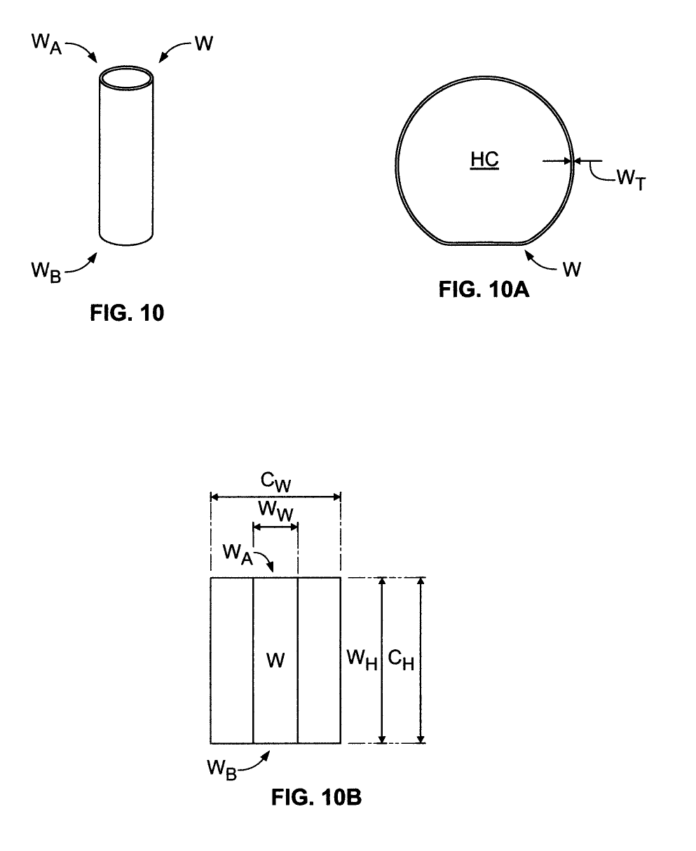

It is further envisioned, and illustrated in FIGS. 10, 10A, and 10B. that the wood wick W maybe more three dimensional (3D) that a thin reed, for example, it maybe a tall cylinder, whether it is a traditional circular cylinder, or non-traditional square cylinder or some other shape, nonetheless, there can be reliefs removed from the outer surface reducing the waistline of the wick W to match the appropriate waistline of the container C. This would be analogous to having a wooden wick W placed on a microscopic lathe, and turned wherein a cutting tool would be used to tailor the outer edge of the wick to match a desired/paired container. Furthermore, it is not necessary to have the relief cut entirely about the waistline of the wick, because in the instance where the container is not symmetrical, then the wick W would need to match the container C, and hence, a relief cut might exist on one side of the wick VV, but not the other.

Furthermore, the interiorness of the cylindrical wick W maybe hollowed out thus providing a more three dimensional (3D) implementation to the wick W than the flatter more two dimensional (2D) like wood wick. This would require either drilling out the core of the wick if it were to remain one piece, or bend and fuse the edges of the wick, or to parse the wick into multiple pieces, and relief cut the core as desired, and then reassemble the pieces back together, in either case, the inner core or part thereof has been removed to some extent, thereby changing the resulting combustion event.

The candle wick system 1 is for use with a parallel walled container C comprising:

a wick W having a height W_{H}, a cross-sectional area, and a thickness W_{T}, wherein said wick W has an apex W_{A} and a base W_{B},

said wick W is hollow cored HC;

wherein the height of said wick W_{H} is about the height of the container C_{H}.

wherein, optionally, the cross-sectional area of the apex is greater than the cross-sectional area of the base, which can be accomplished by reliefs near the base WB, and/or via reduced width.

Moreover, it should be noted, although FIGS. 10, 10A, and 10B illustrate the wick W as a stand alone device, the wick W may also be used in conjunction with the wick dip WC set forth hereinabove, and illustrated in FIGS. 6 to 7A.

All of the above referenced patents; patent applications and publications are hereby incorporated by reference. Many variations of the present invention will suggest themselves to those of ordinary skill in the art in light of the above detailed description. All such obvious modifications are within the Ball-intended spirit and scope of the claims of the present application.

What is claimed is:

1. A candle wick system for use with a parallel walled container populated with a uniform wax comprising:
a wick W having a height W_{H}, a variable cross-sectional area, and a thickness W_{T}, wherein said wick W has an apex W_{A} and a base W_{B}, wherein the cross-sectional area diminishes from the apex WW_{A} to the base WW_{B}; wherein the height of said wick W_{H} is about the height of the container C_{H}.

2. A candle wick system for use with a parallel walled container as in claim 1, having a wick clip WC having a vertical center C, a width WC_{W}, and a height WC_{H} forming a symmetrical profile with a base WC_{B}, sides WC_{S1}, WC_{S2}, and a top WC_{TOP}, defined by a body WC_{BODY} with a wall WC_{WALL} having a width WC_{WALLWIDTH}, and a thickness WC_{T}, wherein a valley V is located at the center of the base WC_{B} having a radius RC formed between two ribs R, wherein each rib R has a radius RC, and a center R, wherein the respective centers of the ribs R are equidistant from the valley V; wherein the wall W extends outwardly from the ribs R, and makes a 90 degree turn vertically upwardly via a curl C having a radius C_{R} defining the overall clip width WC_{W}; wherein the walls WC_{WALL} continue extending vertically and making a 90 degree turn towards the vertical center C via a radius, forming an overall clip height WC_{H}; wherein the respective walls WC_{WALL} curl inwardly with a radius forming pincers P having a gap between the pincers for receiving said wick W.

3. A candle wick system for use with a shoulder container populated by a uniform wax comprising:
a wick W having a height W_{H}, a variable cross-sectional area, and a thickness W_{T}, wherein said wick W has an apex W_{A} , a waist W_{WAIST} and a base W_{B}, wherein cross-sectional area of the waist W_{WAIST} is greater than the cross-sectional area of the apex WW_{A} and the cross-sectional area of the base WW_{B}; wherein the height of said wick W_{H} is about the height of the container C_{H}; wherein the waist W_{WAIST} is located at a height that is about the same plane as the lowest point of the shoulder of the container.

4. A candle wick system for use with a shoulder container as in claim 3, having a wick clip WC having a vertical center C, a width WC_{W}, and a height WC_{H} forming a symmetrical profile with a base WC_{B}, sides WC_{S1}, WC_{S2}, and a top WC_{TOP}, defined by a body WC_{BODY} with a wall WC_{WALL} having a width WC_{WALLWIDTH}, and a thickness WC_{T}, wherein a valley V is located at the center of the base WC_{B} having a radius RC formed between two ribs R, wherein each rib R has a radius RC, and a center R, wherein the respective centers of the ribs R are equidistant from the valley V; wherein the wall W extends outwardly from the ribs R, and makes a 90 degree turn vertically upwardly via a curl C having a radius C_{R} defining the overall clip width WC_{W}; wherein the walls WC_{WALL} continue extending vertically and making a 90 degree turn towards the vertical center C via a radius, forming an overall clip height WC_{H}; wherein the respective walls WC_{WALL} cud inwardly with a radius forming pincers P having a gap between the pincers for receiving said wick W.

5. A candle wick system for use with an artistic container populated by a uniform wax comprising:
a wick W having a height W_{H}, a variable cross-sectional area, and a thickness W_{T}, wherein said wick W has an apex W_{A}, a waist W_{WAIST} and a base W_{B}, wherein a shoulder W_{S} is located between the apex and waist, having a cross-sectional area greater than both the apex and waist:
the wick further having a hip located between the waist and base, and having a cross-sectional area greater than both the waist and base;
wherein the height of said wick W_{H} is about the height of the container C_{H}; the height of the waist of the wick W_{WAIST} is located at a height that is about the same plane as the waist of the container.

6. A candle wick system for use with an artistic container as in claim 5, having a wick clip WC having a vertical center C, a width WC_{W}, and a height WC_{H} forming a symmetrical profile with a base WC_{B}, sides WC_{S1}, WC_{S2}, and a top WC_{TOP}, defined by a body WC_{BODY} with a wall WC_{WALL} having a width WC_{WALLWIDTH}, and a thickness WC_{T}, wherein a valley V is located at the center of the base WC_{B} having a radius RC formed between two ribs R, wherein each rib R has a radius RC, and a center R, wherein the respective centers of the ribs R are equidistant from the valley V; wherein the wall W extends outwardly from the ribs R, and makes a 90 degree turn vertically upwardly via a curl C having a radius C_{R} defining the overall clip width WC_{W}; wherein the walls WC_{WALL} continue extending vertically and making a 90 degree turn towards the vertical center C via a radius, forming an overall clip height WC_{H}; wherein the respective walls WC_{WALL} curl inwardly with a radius forming pincers P having a gap between the pincers for receiving said wick W.

7. A candle wick system for use with a shoulder container populated by a multilayer wax having a plurality of bum rates comprising:
a wick W having a height W_{H}, a variable cross-sectional area, and a thickness W_{T}, wherein said wick W has an apex W_{A} and a base W_{B}, having a plurality of sections each having a height, proximal and distal ends, wherein the height of each section is about the height of each layer of wax;
wherein the proximal end of the first section has a cross-sectional area less than the distal end of the first section wherein the height of the change in area is positioned about the height of the change of the shoulder of the container;
wherein the second section has a cross-sectional area that is greater than the first;
wherein the proximal end of the third section has a cross-sectional area that is smaller than the second, and with a cross-sectional area that is greater than the distal end of the third section;
wherein the height of said wick W_{H} is about the height of the container C_{H}.

8. A candle wick system for use with a multilayer container as in claim 7, having a wick clip WC having a vertical center C, a width WC_{W}, and a height WC_{H} forming a symmetrical profile with a base WC_{B}, sides WC_{S1}, WC_{S2}, and a top WC_{TOP}, defined by a body WC_{BODY} with a wall WC_{WALL} having a width WC_{WALLWIDTH}, and a thickness WC_{T}, wherein a valley V is located at the center of the base WO_{B} having a radius RC formed between two ribs R, wherein each rib R has a radius RC, and a center R, wherein the respective centers of the ribs R are equidistant from the valley V; wherein the wall W extends outwardly from the ribs R, and makes a 90 degree turn vertically upwardly via a curl C having a radius C_{R} defining the overall clip width WC_{W}; wherein the walls WC_{WALL} continue extending vertically and making a 90 degree turn towards the vertical center C via a radius, forming an overall clip height WC_{H}; wherein the respective walls WC_{WALL} curl inwardly with a radius forming pincers P having a gap between the pincers for receiving said wick W.

9. A candle wick system for use with a spittoon like shaped container comprising:
a wick W having a height W_{H}, a variable cross-sectional area W_{CSA}, and a thickness W_{T}, wherein said wick W has an apex W_{A} and a base W_{B},
wherein the cross-sectional area of the wick W_{CSA} is reduced between the apex and base via a first relief portion located about the height of the waist of the container;
wherein the cross-sectional area of the wick is reduced between the apex and base via a second relief portion located near the base;
wherein the height of said wick W_{H} is about the height of the container C_{H}.

10. A candle wick system for use with a spittoon like shaped container as in claim 9, having a wick clip WC having a vertical center C, a width WC_{W}, and a height WC_{H} forming a symmetrical profile with a base WC_{B}, sides WC_{S1}, WC_{S2}, and a top WC_{TOP}, defined by a body WC_{BODY} with a wall WC_{WALL} having a width WC_{WALLWIDTH}, and a thickness WC_{T}, wherein a valley V is located at the center of the base WC_{B} having a radius RC formed between two ribs R, wherein each rib R has a radius RC, and a center R, wherein the respective centers of the ribs R are equidistant from the valley V; wherein the wall W extends outwardly from the ribs R, and makes a 90 degree turn vertically upwardly via a curl C having a radius C_{R} defining the overall clip width WC_{W}; wherein the walls WC_{WALL} continue extending vertically and making a 90 degree turn towards the vertical center C via a radius, forming an overall clip height WC_{H}; wherein the respective walls WC_{WALL} cud inwardly with a radius forming pincers P having a gap between the pincers for receiving said wick W.

11. A candle wick system for use with a parallel walled container comprising:
a wick W having a height W_{H}, a cross-sectional area, and a thickness W_{T}, wherein said wick W has an apex W_{A} and a base W_{B},
said wick is hollow cored; and
wherein the height of said wick W_{H} is about the height of the container C_{H}.

12. A candle wick system as in claim 11, wherein the cross-sectional area of the apex is greater than the cross-sectional area near the base.

13. A candle wick system as in claim 11, wherein the cross-sectional area of near the base is reduced by a reduction in width.

14. A candle wick system as in claim 11, where the cross-sectional area of near the base is reduced by a relief.

15. A candle wick system for use with a tall container as in claim 11, having a wick clip WC having a vertical center C, a width WC_{W}, and a height WC_{H} forming a symmetrical profile with a base WC_{B}, sides WC_{S1}, WC_{S2}, and a top WC_{TOP}, defined by a body WC_{BODY} with a wall WC_{WALL} having a width WC_{WALLWIDTH}, and a thickness WC_{T}, wherein a valley V is located at the center of the base WC_{B} having a radius RC formed between two ribs R, wherein each rib R has a radius RC, and a center R, wherein the respective centers of the ribs R are equidistant from the valley V; wherein the wall IN extends outwardly from the ribs R, and makes a 90 degree turn vertically upwardly via a curl C having a radius C_{R} defining the overall clip width WC_{W}; wherein the was WC_{WALL} continue extending vertically and making a 90 degree turn towards the vertical center C via a radius, forming an overall clip height WC_{H}; wherein the respective walls WC_{WALL} curl inwardly with a radius forming pincers P having a gap between the pincers for receiving said wick W.
